(19) United States
(12) Patent Application Publication
(10) Pub. No.: US 2006/0226170 A1
(43) Pub. Date: Oct. 12, 2006

(54) Method and apparatus for delivering bottled water to an automatic ice maker and water chiller

(76) Inventor: Gregory K. Larsen, Interlachen, FL (US)

Correspondence Address: Douglas Wm. Massinger, Esq.;Massinger Law Offices, 887 N.E. 100 Street, Ocala, FL, 34479, US

(21) Appl. No.: 11/400,609

(22) Filed: Apr. 7, 2006

Related U.S. Application Data
(60) Provisional application No. 60/670,714, filed on Apr. 8, 2005.

(51) Int. Cl. B67D 5/08

(52) U.S. Cl. 222/64

(57) ABSTRACT

An apparatus and method for delivering bottled water to a remote appliance such as a kitchen faucet, refrigerator, coffee maker or beverage dispenser is comprised of a reservoir having means for supporting an inverted water bottle there above, a conduit disposed between the reservoir and a water inlet of the appliance, and a pump along the length of the conduit for injecting purified water under pressure from the reservoir into the appliance. A low liquid level switch is employed for detecting low water level in the reservoir, and a pressure switch is used for turning the pump on and off. A check valve may also be introduced between the pump and the appliance to prevent backflow of water into the reservoir. An alternate embodiment of the system employs bottle support means designed to hold two bottles simultaneously and permit evacuation of their contents into the reservoir in sequence.

### CROSS REFERENCE TO RELATED APPLICATION

This application claims the benefit of the U.S. Provisional Patent Application entitled Pressurized Water Dispenser filed on Apr. 8, 2005 and accorded Ser. No. 60/670,714.

### FIELD OF THE INVENTION

The subject invention relates to bottled water dispensers generally, and to a method and apparatus for delivering bottled water to remote appliances such as a kitchen faucet, or an automatic ice maker and water dispenser of a refrigerator in particular.

### BACKGROUND OF THE INVENTION

The demand for palatable and sanitary drinking water has resulted in an enormous worldwide industry. Because water delivered from municipal drinking water systems and private wells often contains minerals, chlorine and various impurities which impart undesirable taste, odor and color characteristics to the water, and sometimes even make it unsafe for consumption, consumers have turned to purified water or spring water which may be purchased and delivered in bottles. For decades, the state of the art has been and remains to deliver purified water in five gallon plastic containers which must in turn be used in conjunction with some dispensing apparatus.

Most commonly, purified water dispensers are designed to support a single five gallon bottle thereon in an inverted (upside down) position such that the purified water is allowed to flow from the bottle into a holding tank or reservoir in a controlled fashion. The water is then gravity fed through conduit which may be adapted to chill or heat the water, or both, and evacuated through one or more spigots when activated by the user. Such gravity based on-demand systems are relatively expensive when heating and/or cooling features are included. Moreover, gravity based systems provide water at much slower flow rates than pressurized municipal or well water delivery systems.

Notwithstanding the above shortcomings, consumers continue to pay the additional costs associated with having bottled drinking water available because the quality in taste, clarity and healthfulness are believed to be of greater or equal value. Many consumers who are introduced to high quality drinking water later find it difficult to tolerate water from a well or municipal water system. Once consumers become accustomed to high quality drinking water, consumption of ordinary tap water can be somewhat intolerable. One situation when this cannot be avoided is when the consumer is forced to resort to the use of ice cubes dispensed from a refrigerator/freezer unit. Most contemporary units are equipped with built in automatic ice cube dispensers housed within the freezer compartment. Such dispensers typically include a cold water dispenser as well. Because both the water dispenser and the ice cube dispenser are directly connected to the plumbing system of the home or commercial building through which municipal tap water or well water is provided, the water and ice dispensed from these units will suffer from the same quality problems as that dispensed from the tap. Ice cubes will often be cloudy and have an unpleasant odor. Accordingly, beverages chilled using such ice cubes will be fouled. Existing solutions to this problem include filling ice cube containers with purified water from the bottled water dispenser and freezing them or connecting often expensive filtration systems to the tap water.

Clearly it would be of benefit if a means existed for delivering purified water in conventional five gallon bottles directly into ice cube and water dispensing units of refrigerators. It would also be of benefit if a means existed for delivering purified water to other appliances as well, such as to sink spigots, and commercial coffee and beverage dispensing units. The subject invention accomplishes these objectives.

### SUMMARY OF THE INVENTION

In accordance with the teachings of the subject invention an apparatus for delivering bottled water to a remote appliance such as a kitchen faucet, a refrigerator, a coffee maker or beverage dispenser is comprised of a reservoir having means for supporting an inverted water bottle there above, a length of conduit disposed between the reservoir and the water inlet of the appliance to which water is delivered, a pump for pumping water from the reservoir through the conduit and into the appliance, a switch for detecting a low water level in the reservoir, and a pressure switch for turning the pump off and on. Thusly configured, purified water is fed by gravity alone or by gravity and siphon from the suspended bottle to the reservoir and into the conduit, and is then injected into the appliance by the pressure provided by the pump. A check valve may also be introduced between the pump and the appliance to prevent backflow of water from the latter into the reservoir.

In another embodiment of the invention, the reservoir may be fed by two inverted five gallon bottles which are supported in side-by-side arrangement on pivotable support means, one on each side of the pivot. Properly positioned, the openings of both bottles are below water level in the reservoir, however, because of the pivot, one will be slightly higher than the other. The bottle with the greatest volume of water (and therefore the heavier bottle) will cause the bottle with the lesser amount of water (and therefore the lighter bottle) to be pivoted upwards such that its opening is situated approximately one (1″) inch above the opening of the other bottle. In both cases, the opening of the bottle will serve as a “valve” of sorts; when water level reaches the opening it will prevent air from entering the bottle which would otherwise result in water evacuation. However, because one bottle has an opening situated higher than that of the other, its contents will be emptied first. As water is dispensed from the system, the water level in the reservoir will drop below the opening of the higher bottle while the opening of the lower bottle remains submerged. Air is thus permitted to enter the higher bottle allowing it to be drained of its contents. When completely empty, water will eventually drop below the level of the lower bottle permitting it to drain. Such an arrangement provide the user with the ability to sequentially empty two bottles or elect to replace each bottle as they are discharged. Note that the heavier and newly added replacement bottle will always be put in the reserve position until the older bottle is emptied. This prevents the contents of any one bottle from remaining unused and possibly going “stale”. The bottle support means may be further modified to keep the bottles level when raised or lowered by the pivoting action which would otherwise cause them to tilt away from a vertical axis during movement.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is, therefore, a primary object of the subject invention to provide a method and apparatus for delivering purified water from conventional five gallon storage containers to a remote appliance such as a refrigerator, coffee maker, beverage dispenser or kitchen faucet.

It is also a primary object of the subject invention to provide a means for obtaining purified water in chilled form without the need for purchasing a water dispensing apparatus equipped with its own cooling means.

Another object of the subject invention is to provide a purified water delivery system which may be quickly connected to an appliance without modification thereto.

Still another object of the subject invention is to provide a purified water delivery system that is relatively simple in design, comprised of a limited number of components and therefore capable of rapid construction at relatively low costs.

These together with other objects of the invention, along with the various features of novelty which characterize the invention, are pointed out with particularity in the claims annexed to and forming a part of this disclosure. For a better understanding of the invention, its advantages and the specific objects attained by its uses, reference should be had to the accompanying drawings and descriptive matter in which there is illustrated a preferred embodiment of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a diagrammatic illustration of the subject pressurized purified water dispenser for appliances shown connected to a refrigerator having a water chiller and automatic ice maker; and

FIG. 2 is a front sectional view of a pivotable support platform of the subject pressurized purified water dispensing apparatus which permits sequential emptying of two bottles.

REFERENCE NUMBER LIST

| | |
|---|---|
| 10 | Water Dispenser |
| 12 | Water Bottle |
| 14 | Housing |
| 16 | Reservoir |
| 18 | Bottle Support Platform |
| 20 | Opening |
| 22 | Reservoir Evacuation Conduit |
| 24 | Pressure Pump |
| 26 | Pressure Sensor |
| 28 | Pump Motor |
| 30 | 110 volt ac outlet |
| 32 | Water Outlet Conduit |
| 34 | Check Valve |
| 36 | Liquid Level Sensor |
| 38 | Mouth of Bottle |
| 40A, B | Water Bottles |
| 42 | Pivotable Bottle Support Means |
| 44 | Bottle Support Platform |
| 46 | Pivot |
| 48A, B | Platform Openings |
| 50A, B | Bottle Mouths |
| 52 | Water Level |
| 54A, B | Flanges |

Appliance Components Not Part of Invention

| | |
|---|---|
| 100 | Refrigerator |
| 102 | Ice Maker |
| 104 | Water Chiller |
| 106 | Appliance Water Inlet |
| 108 | Internal Appliance Conduit |
| 110 | Ice Holding Tray |
| 112 | On-demand Water/Ice Dispenser |

### DETAILED DESCRIPTION OF THE PREFERRED EMBODIMENT

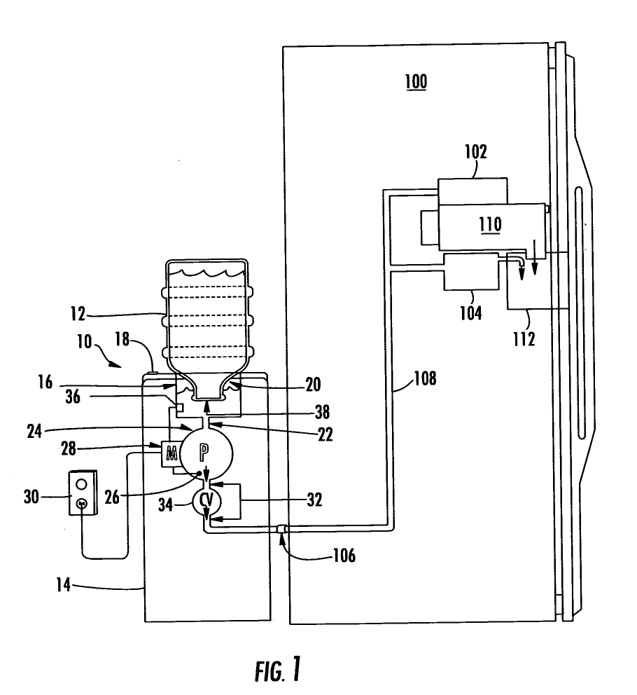

Reference is now made to FIG. 1 in which there is illustrated a first embodiment of the subject water delivery system for remote appliances, designated generally by reference numeral 10. In the example shown, water delivery system 10 is hydraulically interconnected between a conventional five gallon water bottle 12 and a conventional refrigerator appliance 100 so that consumers may enjoy high quality bottled water, such as spring water or purified water, when dispensed from the refrigerator in the form of chilled water, ice cubes or ice shavings.

Refrigerator 100 is equipped with an automatic ice maker 102 and a water chiller 104. Although the arrangement of these components within the refrigerator may vary, they are typically located within the freezer compartment. In the current state of the art, both ice maker 102 and water chiller 104 are supplied water from either a well or municipal water source through the home's pressurized plumbing system. This lower quality water is delivered to refrigerator 100 under pressure via a typically flexible metal conduit (not shown) which is connected to water inlet means 106 which may be a threaded socket or other suitable fitting. Once introduced into the refrigerator, water will pass through internal refrigerator conduit 108 to supply ice maker 102 and water chiller 104. Ice maker 102 typically dispenses ice into a holding tray 110 which may be equipped with means for dispensing ice to the user via an on-demand water and ice dispensing apparatus 112 commonly located in the freezer door.

In order that high quality drinking water may be supplied to refrigerator 100 from bottle 12, water delivery system 10 is employed there between. Note that a conventional water dispensing apparatus (sometimes called a “water cooler”) would not have sufficient water pressure to inject water into a remote appliance because they are gravity fed devices. Water delivery system 10 is comprised of a housing 14 sufficient to accommodate the system's internal components. Because these components are few and of relatively small size, housing may alternately come in a floor model (as shown) or a less cumbersome counter top model. Housing 14 will encase and support therein reservoir 16 having bottle support means which in the embodiment illustrated is a top 18 having an circular opening 20 capable of receiving therein inverted water bottle 12 in a manner well known in the art.

A reservoir evacuation pipe or conduit 22 is connected at one end to the bottom of reservoir 16 and at its other end to the intake of pump 24. Pump 24 is preferably of the on-demand variety and equipped with built-in pressure switches 26 which alternately and automatically turn on pump motor 28 when water system pressure drops, and shut down pump motor 28 when pressure reaches a predetermined cut-off level. Such an arrangement is ideal for circulating water from reservoir 16 to the remote appliance. Pump motor 28 is powered by a 110 volt outlet 30 which is preferably located in close proximity to the operating environment of the subject apparatus.

Pump 24 is suitably equipped with a flexible outlet conduit 32 having a length sufficient to exit housing 14 and preferably, but not essentially, to reach and be connected to the input 106 of refrigerator 100 or any other appliance into which a consumer may wish to inject purified water. When the length of outlet conduit 32 is not sufficient to reach the input of the target appliance, a length of flexible extension conduit (not shown) may be employed. As may be appreciated; pump 24 may alternatively be equipped With a rigid outlet pipe which exits the housing and is connected to the aforementioned flexible extension conduit.

A check valve 34 is disposed between pump 24 and the target appliance, preferably within housing 14 as shown. Check valve 34 is a one-way check valve which permits water to flow from pump 24 to the target appliance, but prevents water from flowing in the opposite direction. Accordingly, when pump 24 is not activated, water will be prevented from back flowing into reservoir 16. Some pumps may include features which prevent backflow making the use of check valve 34 unnecessary.

A liquid level sensor 36 is also operatively connected to the interior wall or base of reservoir 16 and electronically connected to pump motor 28 for turning the pump off when the water level within the reservoir falls below a pre-selected point. This will prevent pump motor 28 and corresponding pump 24 from running dry and burning out.

Thusly configured, purified water is fed by gravity alone or by gravity and siphon from the mouth 38 of inverted bottle 12 into reservoir 16 and then conduit 22, and is then injected into the appliance by the pressure provided by pump 24. More specifically, when a user causes water to be dispensed from the appliance (such as when dispensing chilled water from a refrigerator, coffee from a coffee maker, or some other beverage from its dispensing apparatus, water pressure in water evacuation conduit 32 and pump 26 is caused to drop, and pressure switch 26 closes to actuate pump motor 28 for pump 26 to provide a flow of water from the reservoir to the appliance. The same process occurs when an automatic ice maker causes the opening of its water supply line to fill the ice maker with water for freezing. The resulting water flow causes a decrease in water pressure in the system causing pressure switch to close. When the user has obtained the desired quantity of water or other beverage from the appliance and the dispenser unit closes, pressure builds in the system generally, and in the pressure pump in particular, causing the pressure switch to open and turn the pump motor off. It should be appreciated that no modification is required to refrigerator 100 to accept and work with the subject water delivery system 10 which might otherwise void product warranties. Moreover, the subject water delivery system 10 requires no water chilling unit of its own when used in combination with a refrigerator adapted with a water chiller 104. Alternate embodiments of the subject invention may, however, be equipped with internal water heating and chilling devices which in turn are connected to external spigots for direct supply of hot and cold water from the system.

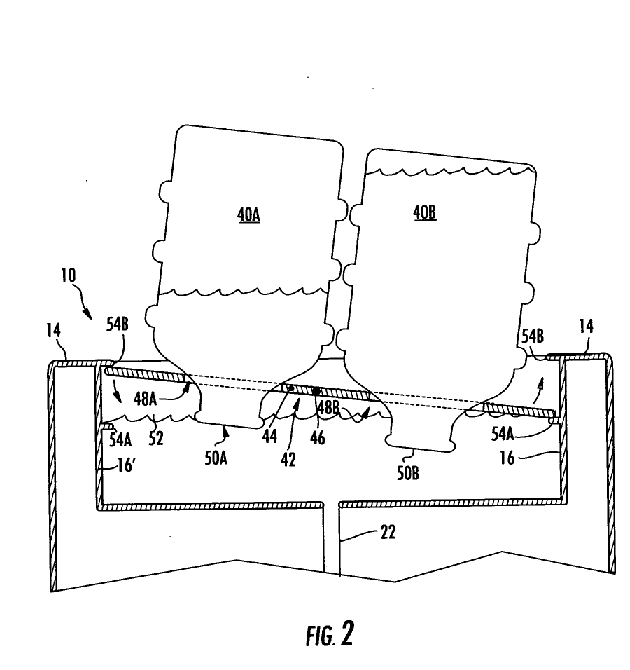

Reference now being made to FIG. 2, another embodiment of the subject water delivery system 10 is illustrated which permits sequential dispensing of water from two purified water bottles 40A and 40B. More specifically, FIG. 2 illustrates a front sectional view of pivotable bottle support means 42, comprised of bottle support platform 44 pivotally attached to housing 14 via pivot 46. Pivot 46 in the embodiment illustrated consists of a transverse rod extending from one side of housing 14 to the opposite side thereof and may either be disposed through bottle support platform 44 at its midpoint as shown or be mounted above or below its midpoint. Bottle support platform has two openings 48A and 48B; one on each side of pivot 46, for the receipt of bottles 40A and 40B, respectively.

When water bottles 40A and 40B are mounted in an inverted position within corresponding openings 48A and 48B of platform 44, their mouths 50A and 50B will extend into underlying reservoir 16. Water will continue to flow into and fill reservoir 16 until the water level 52 rises above the mouth of each bottle. However, unless the bottles and their contents are identical in weight, bottle support platform will pivot to one side such that bottles 40A and 40B will no longer occupy the same horizontal plane (i.e., one will be higher than the other). Assuming the bottles are of the same weight when empty, the bottle with the greatest volume of water (in this case bottle 40B), and therefore the heavier bottle, will cause the bottle with the lesser amount of water (bottle 40A), and therefore the lighter bottle, to be pivoted upwards such that its mouth 48A is situated above the mouth of bottle 48B. The degree to which the bottles may be pivoted relative to one another may be limited by pivot limitation means which in this case is comprised of a pair of flanges 54A and 54B extending into reservoir 16 from its interior wall, one above the axis of rotation of pivot 46 and one below. It should be appreciated that flanges 54A,B serve as ledges or “stops” against which bottle support platform 44 will come in contact when pivoted about pivot 46, thereby limiting its degree of rotation about a horizontal axis. A height difference of at least ½″ between one end of bottle support platform 44 relative to its other end is preferred when fully pivoted. Note that the embodiment of FIG. 2 further includes all of the other components described above in relation to the first embodiment of FIG. 1 and, except as noted below, functions in the same manner to deliver purified water to the target appliance.

Mouths 48A,B of bottles 40A,B each serve as a “valve” of sorts; when water level 52 reaches the mouth opening it will prevent air from entering the bottle which would otherwise result in water evacuation into reservoir 16. However, because one bottle has an opening situated higher than that of the other, its contents will be emptied first. As water is caused to be evacuated from reservoir 16 into reservoir evacuation conduit 22, water level 52 in the reservoir will drop below the mouth opening of the higher bottle while the opening of the lower bottle remains submerged. Air is thus permitted to enter the higher bottle allowing it to release its contents until the water level rises to a height sufficient to “close the valve”. When the higher bottle becomes completely empty, water level 52 will eventually drop below the level of the lower bottle permitting it to drain. Such an arrangement provides the user with the ability to sequentially empty two bottles, one after the other, or to replace each bottle as they are discharged. Note that the heavier and newly added replacement bottle will always descend to the lower “reserve position” until the bottle in the higher “active position” is emptied. This prevents the contents of any one bottle from remaining unused and possibly going “stale”. It is believed that certain retail establishments will benefit from the dual water bottle embodiment of the subject water delivery apparatus such as, for example, coffee shops which connect the system to large volume commercial coffee makers. When such establishments become exceptionally busy with heavy customer traffic it will not be necessary to immediately replace an empty water bottle as would be the case when a singe bottle dispensing unit is employed.

It is important to note that pivotable bottle support means 42 may be designed in multiple other ways. In another embodiment (not shown) two separate but connected bottle support platforms operate dependently of one another such that when one platform is caused to be lowered by a heavier water bottle, it causes the other platform to rise; each platform remains level during movement from the active to the reserve positions. Accordingly, the bottles supported on the platforms will not be caused to tilt from their vertical axis.

Although the present invention has been described with reference to the particular embodiments herein set forth, it is understood that the present disclosure has been made only by way of example and that numerous changes in details of construction may be resorted to without departing from the spirit and scope of the invention. Thus, the scope of the invention should not be limited by the foregoing specifications, but rather only by the

What is claimed as being new, useful and desired to be protected by letters patent of the United States is as follows:

1. A water delivery system for delivering water from a container to an appliance, comprising:
a. means for supporting an inverted water container above a reservoir such that water contained in the container is permitted to flow into the reservoir;
b. a conduit having a first end connected to said reservoir;
c. a pump connected to a second end of said conduit;
d. a water outlet conduit having a first end connected to said pump and a second end removably connected to the water inlet of the appliance; and
e. a pressure switch operably connected to said pump for alternately turning the pump on and off when water pressure in the system is caused to decrease and increase, respectively.

2. A water delivery system for sequentially delivering water from two containers to an appliance, comprising:
a. pivotal support means for supporting two inverted water containers above a reservoir; said pivotal support means including a container support platform bisected by a pivot, said container support platform having a first opening on one side of said pivot and a second opening on the other side of said pivot such that the two inverted water containers supported by said openings may be pivoted to different heights with respect to one another;
b. a conduit having a first end connected to said reservoir;
c. a pump connected to a second end of said conduit;
d. a water outlet conduit having a first end connected to said pump and a second end removably connected to the water inlet of the appliance; and
e. a pressure switch operably connected to said pump for alternately turning the pump on and off when water pressure in the system is caused to decrease and increase, respectively.

3. A method of delivering water from a container into an appliance, comprising the steps of:
a. supporting an inverted water container above a reservoir such that water in the container is permitted to flow into said reservoir;
b. permitting water to flow by gravity and/or siphon from said reservoir into a conduit having a first end connected to said reservoir and a second end connected to a pump;
c. pumping water contained within said reservoir and said conduit through a water evacuation conduit having a first end connected to said pump and a second end connected to a water inlet of the appliance when water pressure within said pump decreases below a preset limit.
